(19) United States
(12) Patent Application Publication
(10) Pub. No.: US 2012/0014099 A1
(43) Pub. Date: Jan. 19, 2012

(54) Lamp

(75) Inventors: Young Hoon An, Daejeon (KR); Kwang Soo Kim, Daejeon (KR); Kyu Sop Song, Daejeon (KR)

(73) Assignee: APACK, INC., Daejeon (KR)

(21) Appl. No.: 12/868,186

(22) Filed: Aug. 25, 2010

(30) Foreign Application Priority Data
Jul. 13, 2010 (KR) 10-2010-0067261

(51) Int. Cl. F21S 4/00

(52) U.S. Cl. 362/249.02

(57) ABSTRACT

Provided is a lighting system having a printed circuit board on which a plurality of light emitting diodes are arranged; a base holding the printed circuit board; a heat sink provided on a lateral side of the base in a horizontal direction of the printed circuit board; a heat pipe which connects the base with the heat sink; and a rotating unit provided in at least end portion of one end portions and the other end portions of the base or the heat sink, to easily control the illuminating angle and the illuminating range and therefore to improve the energy efficiency, and to improve the heat-radiating property since the heat sink is provided in the lateral side of the substrate of heat-generating member.

### CROSS-REFERENCE(S) TO RELATED APPLICATIONS

The present invention claims priority of Korean Patent Application No. 10-2010-0067261, filed on Jul. 13, 2010, which is incorporated herein by reference.

### BACKGROUND OF THE INVENTION

1. Field of the Invention

The present invention relates to a lighting system using a light-emitting diode; and, more particularly, to a lighting system which has a heat sink formed on a lateral portion of a printed circuit board, which is heat-generated by the light-emitting diode, to enable achieving an improved thermal heating performance and easily controlling a range of an illuminating angle by means of a rotating unit and a holding bracket, as well as of being modularized.

2. Description of Related Art

Conventionally, the lighting system is mounted on a ceiling of an indoor to be responsible for lighting an indoor space; and provides the light for indoor space using a lamp which is configured within a housing of given shape such as rectangular or round shape to be controllably turned on or off according to whether the current is applied or not on user's intention.

As the lamp of the general lighting system, a fluorescent lamp or an incandescent bulb are mainly used, and such fluorescent lamp or incandescent bulb have problems such as a large power consumption, a reduced life time and a low illuminance.

In order to resolve such problems, there is proposed a technology of applying Light Emitting Diode LED of a high illuminance and a long life-time even with low power consumption.

The light-emitting diode is an optoelectronic element having a junction structure of P type and N type semiconductor to discharge the light of energy corresponding to bandgap of the semiconductor if electrons and holes combine when power is applied, and it is spotlighted as the lighting means of a high efficiency since a response time is higher compared with the general bulb and the consumed power is lower by 20% compared with the general bulb even when the illuminance is higher.

Since the light emitting diode generates significant heats during emitting, the generated heat may likely damage the light emitting diode and a Printed Circuit Board PCB. Therefore, the illuminance performance and the life time thereof are degraded if a proper heat-radiating means is not provided.

FIG. 1 shows a lighting system to which a prior light emitting diode is applied; and FIG. 2 shows a cross-section of the lighting system to which the prior light emitting diode is applied. As shown, the lighting system 1000 using the light emitting diode is configured with a printed circuit board 110, a light emitting diode 111 provided on one surface of the printed circuit board, and a heat sink 130 provided on a back surface of the printed circuit board, i.e., a surface opposite to a surface on which the light emitting diode 111 is provided to discharge the heat generated from the light emitting diode 111.

A heat energy H generated during emitting of the light emitting diode 111 is discharged to outside through the heat sink 130 located on a top portion of the printed circuit board 110. Since the heat energy H generated from the light emitting diode 111 is transferred to the heat sink 130 through the printed circuit board 110, the heat energy H is effectively not transferred, and particularly since insulating layer is formed on an upper side of the printed circuit board 110, the heat transfer efficiency is lowered.

Further, as the heat sink 130 is located adjacent to a ceiling, there are problems in that it is not possible to be cooled effectively by natural convection and it has many difficulties to change an illuminating angle and an illuminating range.

Although there is proposed to expand a volume of the heat sink 130 in order to resolve the above-mentioned problems, a weight along with the total volume of the lighting system 1000 is increased so that limitations on installing are incidental and a production cost is increased.

FIG. 3 shows another example of the lighting system using the prior light emitting diode. The lighting system shown in FIG. 3 is configured with a heat plate 120 integrally formed with the printed circuit board 110, a light emitting diode 111 mounted on a top surface of the heat plate 120, and a heat pipe 140 is cylindrical-shaped to connect the heat plate 120 with the heat sink 130.

The heat sink 130 is used as a heat-radiating means, and the heat pipe 140 of cylindrical type connected to the heat sink 130 is used as a heat-transferring means, in which the heat energy generated from the light emitting diode 111 is moved to the heat sink 130 via the heat pipe 140 through the heat plate 120 integrally formed with the printed circuit board 110.

Herein, since the printed circuit board 110 to which the heat energy generated from the light emitting diode 111 is directly transferred while providing the power to the light emitting diode 111 is integrally formed with the heat plate 120, there is a difficulty in producing it, as well as individual replacement and repair is impractical and therefore entire can be replaced when the heat plate 120 or the printed circuit board 110 is damaged.

Further, if working fluid charged within the heat pipe 140 is leaked, the lighting system including the light emitting diode 111 is consecutively damaged, as well as secondary problems are incidental.

Since the prior lighting system is inevitably enlarged for increasing the illuminance, the production equipment is enlarged and the production cost is increased, which results in an additional problem of lower productivity.

Since the prior lighting system has the illuminating angle set only at a certain angle, there are problems in that the mounting location is limited to a given range and it is impossible to change the illuminating angle after mounting.

Subsequently, there is a need for a scheme of causing the heat generated from the light emitting diode to be effectively radiated to improve a durability of the lighting system and easily control the distribution of light energy and the illuminating angle and the illuminating range even in a high-output illuminating device such as the lighting system.

### SUMMARY OF THE INVENTION

An embodiment of the present invention is directed to provide a lighting system which has a heat sink mounted in the lateral horizontal direction of the printed circuit board with the light emitting diode to radiate the heat generated from the light emitting diode, to improve the radiating performance and cause the distribution of the light source and the illuminating angle and the illumination range to be facilitated via easy modularization of the lighting system.

To achieve the object of the present invention, the present invention provides a lighting system comprising a printed circuit board 10 on which a plurality of light emitting diodes 11 are arranged; a base which holds the printed circuit board 10; a heat sink 30 which is provided on a lateral side of the base 20 in a horizontal direction of the printed circuit board 10; a heat pipe 40 which connects the base 20 with the heat sink 30; and a rotating unit 50 which is provided in at least end portion of one end portions and the other end portions of the base 20 or the heat sink 30.

Preferably, the rotating unit 51 is provided with an angle control unit 51.

Preferably, the heat sink 30 is provided with a housing 35 having an air-passing portion 36 formed.

Preferably, the base 20 is provided with a first setting unit 21 which surrounds one portion or all of an outer circumference of the heat pipe 40.

Preferably, the heat sink 30 is provided with a second setting unit 31 which surrounds one portion or all of an outer circumference of the heat pipe 40.

Preferably, the lighting system 100 is provided with a holding bracket 60 having a rotation guide unit 61 which is fitted into the rotating unit 51 to guide it to rotate in a left side and a right side about an axis direction.

Herein, at least one rotation guide unit 61 is provided.

Further, the holding bracket 60 is made from a metal material and provided with a heat-radiation facilitating means 62 on a surface thereof.

### BRIEF DESCRIPTION OF THE DRAWINGS

FIG. 1 is a perspective view showing a lighting system to which a prior light emitting diode is applied.

FIG. 2 is a cross-sectional view showing a lighting system to which a prior light emitting diode is applied.

FIG. 3 is a decomposed perspective view showing another example of a lighting system to which a prior light emitting diode is applied.

FIG. 4 is a perspective view showing a lighting system according to the present invention.

FIG. 5 is a decomposed perspective view showing a lighting system according to the present invention.

FIG. 6 is a short-direction cross-sectional view showing a lighting system according to the present invention.

FIG. 7 is a long-direction cross-sectional view showing a lighting system according to the present invention.

FIG. 8 is a drawing showing various examples of the base.

FIG. 9 is a perspective view showing various utilization of the lighting system according to the present invention.

FIG. 10 is a drawing showing various examples of the bracket.

FIG. 11 is a perspective view showing a modularization of the lighting system according to the present invention.

FIG. 12 is a perspective view of another example showing a modularization of the lighting system according to the present invention.

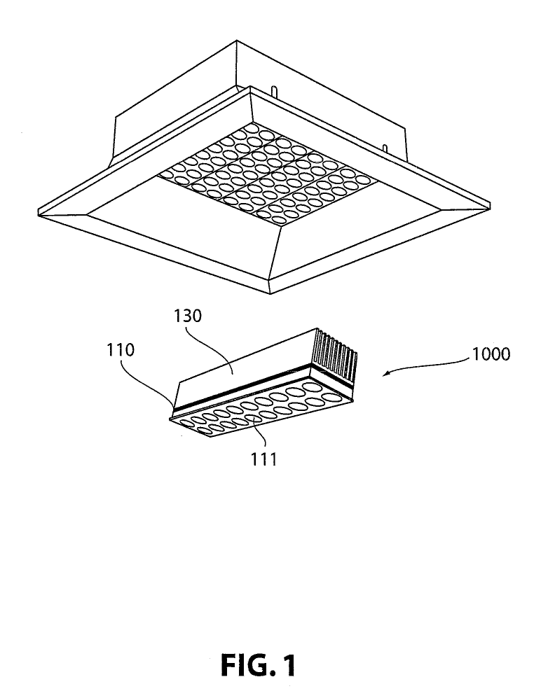

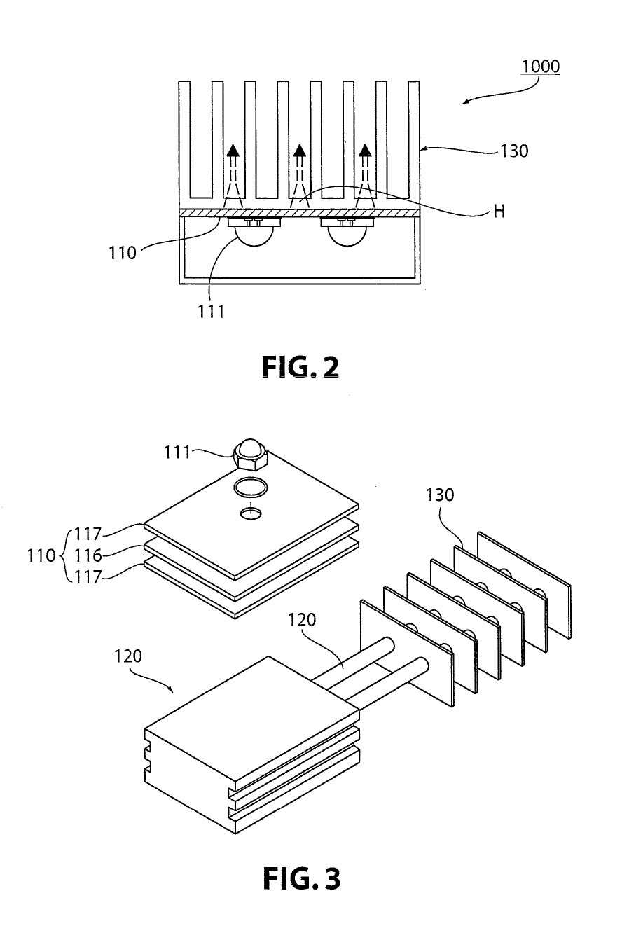

### DETAILED DESCRIPTION OF MAIN ELEMENTS

10: printed circuit board 11: light-emitting diode
12: cap 13: protective cover
15: space portion 20: base
21: first setting portion 30: heat sink
31: second setting portion 32: heat-radiating pin
35: housing 36: air-passing portion
40: heat pipe 50: rotating unit
52: holding portion 60: holding bracket
61: rotation guide portion
62: heat radiation facilitating means
70: connecting member
100: lighting system according to the present invention
H: heat energy

### DESCRIPTION OF SPECIFIC EMBODIMENTS

The advantages, features and aspects of the invention will become apparent from the following description of the embodiments with reference to the accompanying drawings, which is set forth hereinafter.

A lighting system 100 according to the present invention will be explained referring to accompanying drawings.

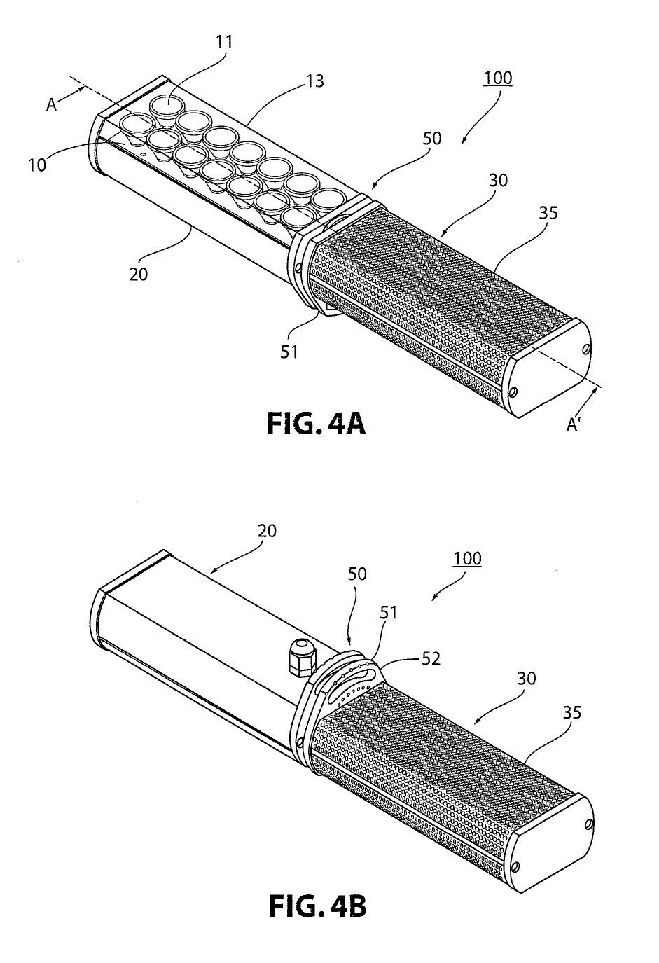

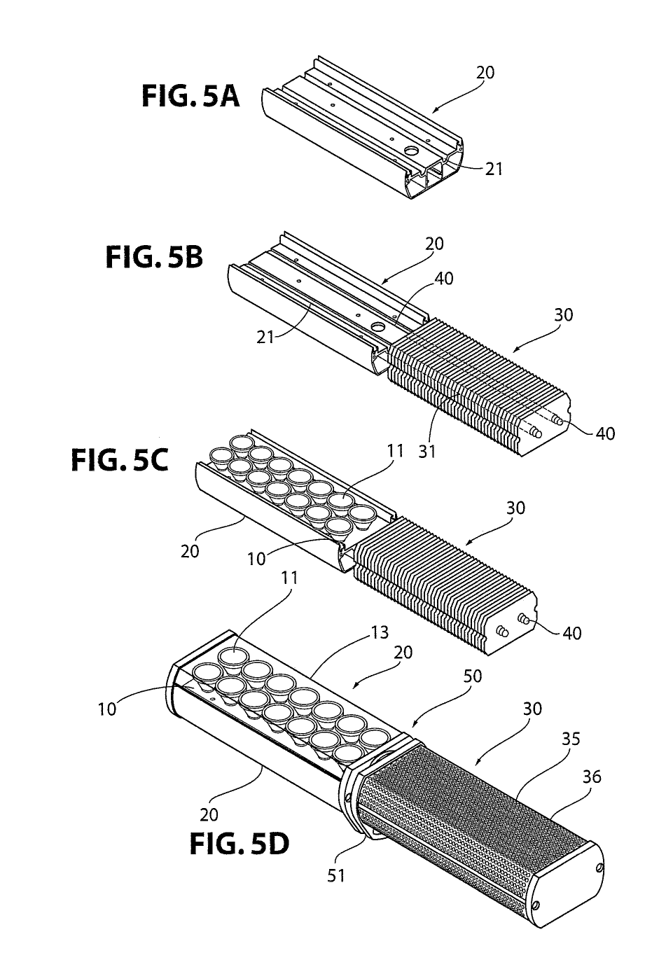

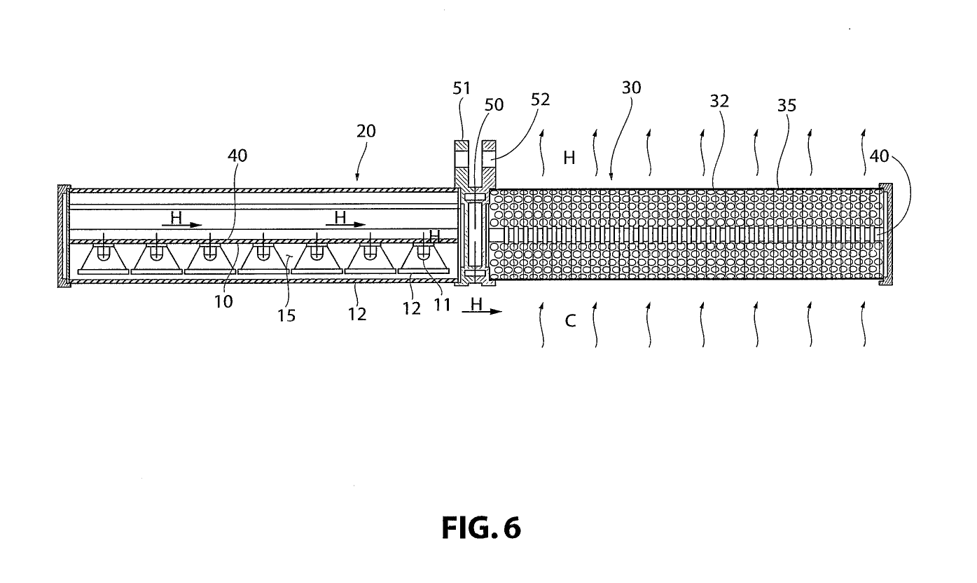

FIGS. 4 to 7 are a perspective view, a decomposed perspective view and a cross-sectional view of the lighting system according to the present invention. As shown, the lighting system 100 according to the present invention is configured with a printed circuit board 10 in which a plurality of light emitting diode 11 is arranged, a base 20 which holds the printed circuit board 10, a heat sink 30 which is formed on a lateral side of the base 20, a heat pipe 40 which connects the base 20 with the heat sink 30, and a rotating unit 50 with an angle control unit 51.

The printed circuit board 10 on which the plurality of light emitting diode 11 is arranged may be responsible for holding the light emitting diode 11 and supplying the power to the light emitting diode 11.

The base 20 is made from materials which is strong enough to hold the printed circuit board 10 and prevent the printed circuit board 10 from an attack and a contamination from outside; and is formed to surround the back surface of the printed circuit board 10 (a surface opposite to a surface on which the printed circuit board is arranged).

Preferably, the base 20 has a given strong property to prevent the printed circuit board 10, as well as is made from metal material of copper or aluminum which is superior at heat conductivity to allow the heat energy H generated from the light emitting diode 11 to be transferred rapidly to the heat sink 30 via the heat pipe 40 later-described and to be radiated directly to the outside.

The base 20 with the printed circuit board 10 being held thereon has a transparent or non-transparent protective cover 13 formed on the front surface of the printed circuit board 10 (a surface on which the light emitting diode is arranged) and has a cap 12 of various shapes selectively arranged to ensure a variety of light emitted from the light emitting diode 11.

In addition, a space portion 15 between the light emitting diode 11 and the protective cover 13 can be charged with an epoxy resin containing a light diffuser in order to reduce the directivity of the light emitted from the light emitted diode 11 and thereby generate the smooth light.

The heat sink 30 is responsible for allowing the lighting system 100 with the light emitting diode 11 not to be damaged by causing the heat energy generated from the light emitting diode 11 to be radiated rapidly to the outside; and formed in the lateral side of the base 20 with a structure that a surface area thereof may be expanded to provide for greater effective heat-radiation.

Since the heat sink 30 of cooling unit is distinctly separated from the heat-generating unit 10, 11, 20 in a manner that the heat sink 30 is formed on the lateral side of the base 20 in a horizontal direction of the printed circuit board 10 with the light emitting diode 11, the cooling performance may be improved. Further, the cooling efficiency may be improved due to the structure that the natural convection is smoothly achieved. Herein, although the heat sink 30 is preferably consisted with a plurality of heat-generating pins as shown, it can be modified to other structures having expanded surface area without limitation to it.

A housing 35 of protection means is formed on the outside of the heat sink 30 to prevent the heat-radiation structure from being damaged as shown. The housing 35 has an air-passing portions 36 formed to cause air inside and outside the heat sink 30 to be communicated to each other. A plurality of the air-passing portions 36 has a cross-section of round or hexagon shape and is formed over one portion or total portion of the housing 35.

The heat pipe 40 which connects the base 20 with the heat sink 30 to allow the heat energy H generated from the light emitting diode 11 to be rapidly transferred to the heat sink 30 is made from metal material of copper or aluminum having superior heat-conductivity.

The heat pipe 40 is to allow the heat energy H generated from the light-emitting diode 11 to be transferred to the heat sink 30 and is connected from the inside of the base 20 to the heat sink 30 on the back surface of the printed circuit board 10 (a surface opposite to a surface on which the light emitting diode is arranged).

Since the heat pipe 40 is fitted and held in a first setting portion 21 formed on the base 20, it can be stably held. Further, a contact surface between the base 20 and the heat pipe 40 is increased thereby to improve the heat conduction performance between each other.

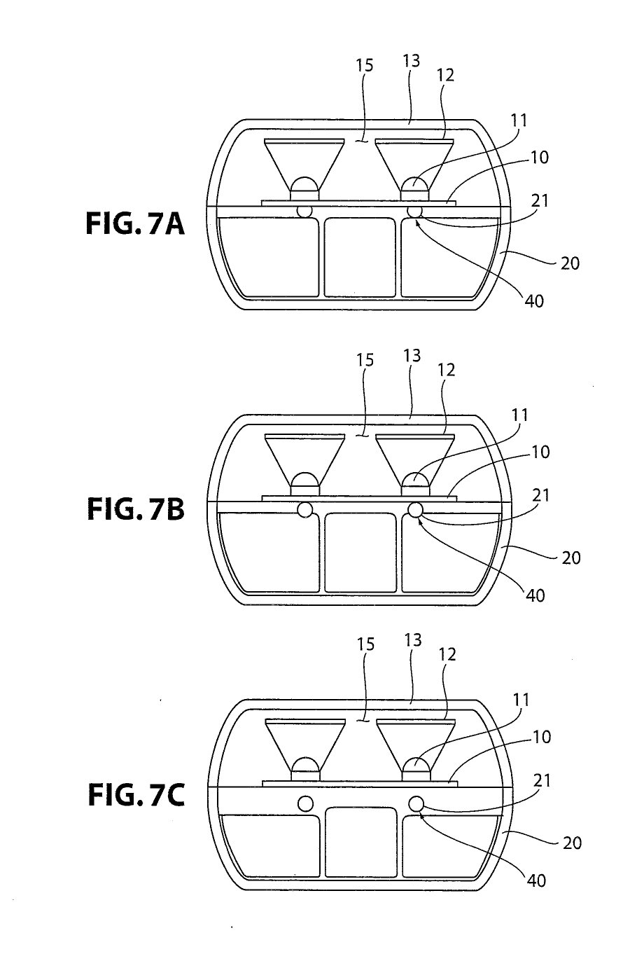

The heat pipe 40 fitted and held in the first setting portion 21 can be formed to make it contact to the back surface of the printed circuit board 10 as shown in FIG. 7a, formed to allow it to be separated from the printed circuit board 10 by a certain distance as shown in FIG. 7b, and formed to allow it to be inserted into the base 20 to completely be sealed as shown in FIG. 7c.

As the heat pipe 40 is formed to be contacted or be separated by the certain distance to/from the back surface of the printed circuit board 10 as shown in FIG. 7a and FIG. 7b, there are advantages in that the production process is simplified and the replacement of the heat pipe 40 is possible according to the situations. As the heat pipe 40 is inserted into the base 20 on the back surface of the printed circuit board 10 to completely be sealed as shown in FIG. 7c, it is possible to ensure the water-resistance of preventing the water from being absorbed, which is a main point in heating equipments.

The heat pipe 40 which is connected from the base 20 to the heat sink 30 is preferably formed to make it surface-contact to the heat sink 30, and for the purpose of it, the heat pipe 40 may be fitted and held into a second setting portion 31 within the heat sink 30.

The second setting portion 31 may be formed within the heat-radiating pin 32 composing the heat sink 30 or on a surface of the heat-radiating pin 32 composing the heat sink 30.

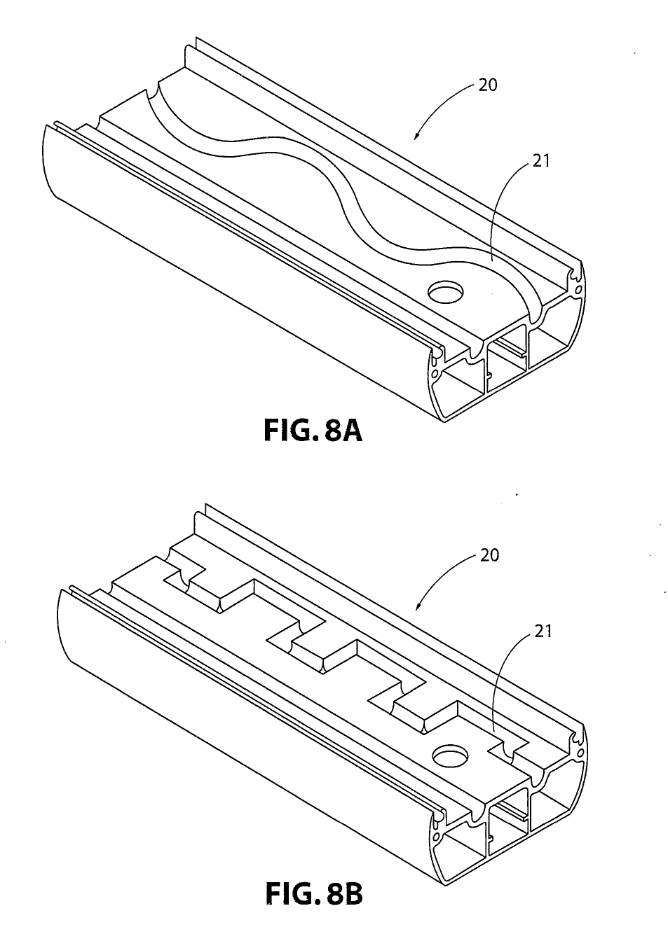

FIG. 8 shows another embodiment which improves the heat conductive performance between the base 20 and the heat pipe 40 by changing a holding structure between the base 20 and the heat pipe 40. The heat pipe 40 and the first setting portion 21 may be formed with a corrugate-type and the heat pipe 40 as shown in FIG. 8a, and the heat pipe 40 and the first setting portion 21 may be also formed with a concave and convex type as shown in FIG. 8b. The holding structure between the base 20 and the heat pipe 40 can be changed by arranging the heat pipe 40 to be contact or separated by a certain distance to/from the back surface of the printed circuit board 10 or inserting it completely into the interior of the base 20 on the back surface of the printed circuit surface 10 as shown in FIGS. 7a to 7c. The embodiment shown in FIG. 7a has a difficulty in completely realizing the water-resistance of the printed circuit board 10, whereas the embodiments shown in FIG. 7b and FIG. 7c can realize the complete water-resistant structure.

The holding structure between the heat pipe 40 and the heat sink 30 can be also changed based on the embodiments shown in FIGS. 7a to 7c and FIGS. 8a and 8b.

The rotating unit 50 can control the illuminating angle and the illuminating range of the lighting system 100 according to the present invention by cause the lighting system 100 to be rolled about the axis direction, i.e., to be rotated by a given distance in the left side and the right side about on the axis direction; and the rotating unit 50 has a cross-section of round to cause the lighting system 100 to be rotated in the left side and the right side about the axis direction and is formed between the base 20 and the heat sink 30, as shown in FIGS. 4 to 6.

Although the rotating unit 50 is preferably formed on the opposing portion between the base 20 and the heat sink 30, it can be formed on one end portion or both end portions of the base 20 and one end portion or both end portion of the heat sink 30. In other words, the rotating unit 50 can be formed on at least one of one end portions and the other end portions of the base 20 and the heat sink 30.

Further, the rotating unit 50 has the angle control unit 51 extended thereto, and the angle control unit 51 holds the lighting system 100 rotated to the left side and the right side about the axis direction to keep the illumination angle constant.

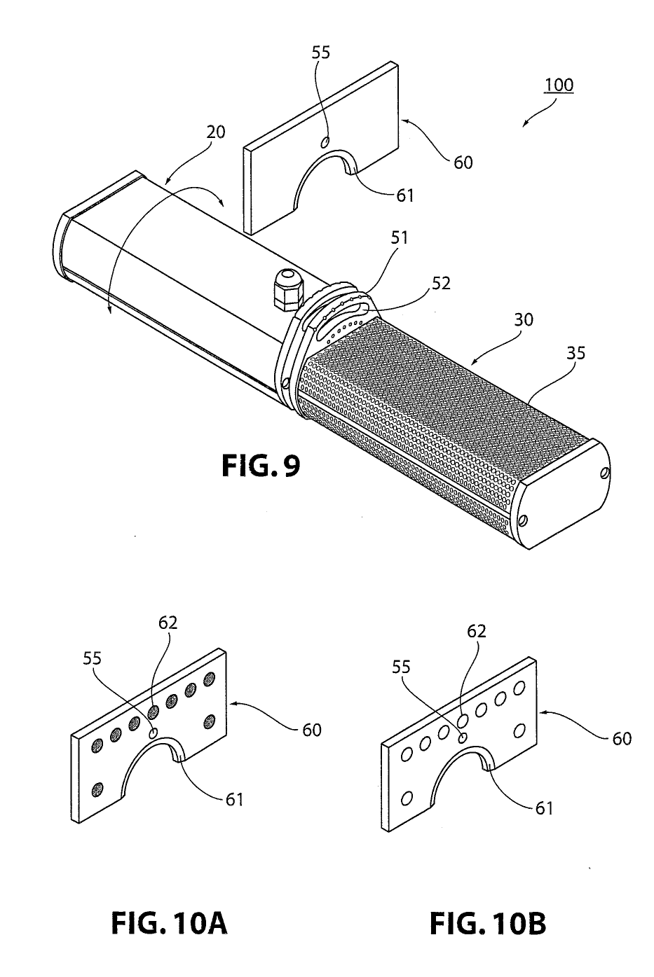

FIG. 9 is a drawing showing the detailed holding structure of the rotating unit 50 and the angle control unit 51 and the lighting system 100, and it will be described on the rotating unit 50 and the angle control unit 51 referring to FIG. 9.

The rotating unit 50 is enabled to rotate the lighting system 100 by a given distance in the left side and the right side about the axis direction thereby to control the illuminating angle and the illumination range of the lighting system 100; and mounted on the holding bracket 60 as shown in FIG. 9

The holding bracket 60 is to hold the lighting system 100 according to the present invention and has a rotation guide unit 61 formed to fitted and held into the rotating unit 50. The rotating unit 50 inserted into the rotation guide unit 61 is rotated along the rotation guide unit 61 and therefore the lighting system 100 can allow the illuminating angle and the illuminating range to be changed.

The angle control unit 51 extended form the rotating unit 50 limits motions of the rotating unit 50 to keep the illuminating angle of the lighting system 100 constant and a holding portion 52 is formed to be fitted and held into a holding aperture 55 formed in the holding bracket 60. The holding portion 52 in the angle control unit 51 and the holding aperture 55 in the holding bracket 60 may be preferably structured as mentioned-above, but on the contrary, the holding hole 55 may be formed in the angle control unit 51 and the holding portion 52 fitted and held into the holding aperture 55 may be formed in the holding bracket 60.

The holding bracket 60 is made from materials of given strength which have excellent heat-radiating property so that the heat energy is enabled to transferred through the rotating unit 50. Further, heat-radiation facilitating means 62 is protruded upon a surface of the holding bracket 60 to improve the heat-radiation property as shown in FIG. 10a. The heat-radiation facilitating means 62 can be formed with a hole in the holding bracket 60. The heat-radiation facilitating means can be changed without limitation to it if the heat-radiation performance can be improved.

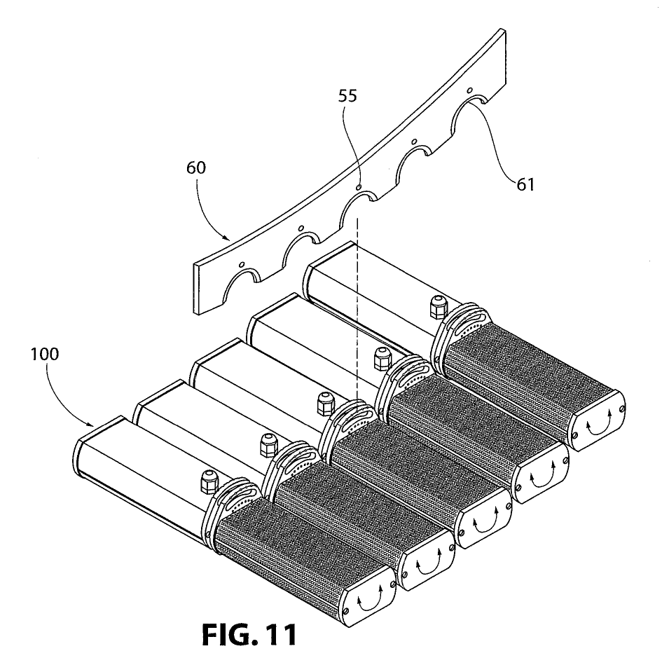

FIG. 11 is a drawing showing a detailed modularization of the lighting system 100 according to the present invention. As shown in FIG. 11, the holding bracket 60 has a plurality of rotation guide units 61 and the rotating unit 50 of the lighting system 100 is fitted and held respectively into the plurality of rotation guide units 61, which results that the modularization of the lighting system can be realized according to the present invention.

There is an advantage of higher utilization since the illuminating range can be variously implemented by making a difference in a height and a width of the plurality of rotation guide units 61 formed in the holding bracket 60 and the amount of light can be easily controlled by reducing or increasing the number of the rotation guide units 61.

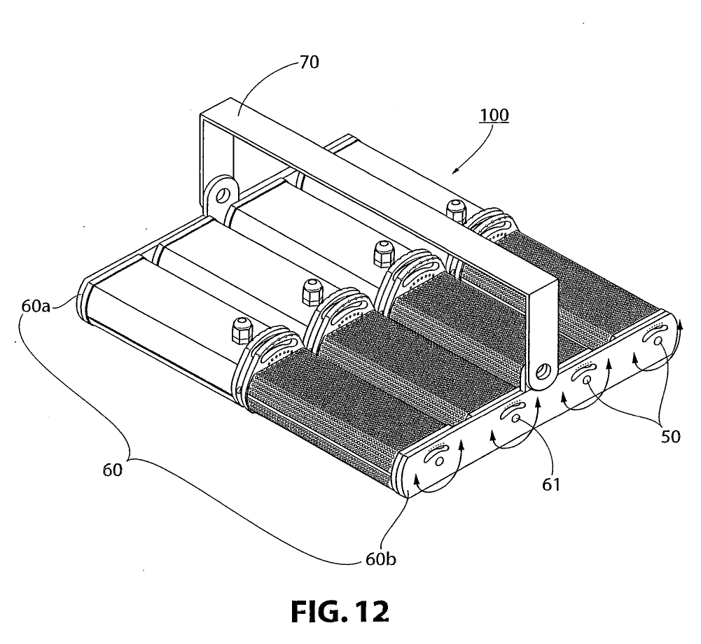

FIG. 12 shows another embodiment of modularization of the lighting system according to the present invention. As shown in FIG. 12, the rotating units 50 are formed respectively on the external end portion of the base 20 and the external end portion of the heat sink 30; and the holding brackets 60a, 60b having the rotation guide unit 61 which is opposite to the rotating unit 50 and fitted into the rotating unit 50 to guide it to rotate are arranged respectively in the outside of the base 20 and the outside of the heat sink 30. The holding bracket 60a in the outside of the base 20 and the holding bracket 60b in the outside of the heat sink 30 are connected to each other through the connecting member 70.

The lighting system 100 according to the present invention is fitted and held into the holding brackets 60a, 60b which are arranged respectively in the outside of the base 20 and the outside of the heat sink 30. At this time, as it is possible to rotate between the rotating unit 50 and the rotation guide unit 61, the lighting system 100 according to the present invention is enabled to rotate at a certain degree in the left side and the right side about the axis direction.

As shown, the plurality of rotation guide units 61 is formed to cause the plurality of lighting systems 100 to be fitted and held in the holding brackets 60a, 60b and the rotating unit 50 of the lighting system 100 is fitted and held into each of the rotation guide units 61, which results that the modularization of the lighting system 100 can be realized according to the present invention.

The lighting system 100 can be structured such that individual lighting system composing the module can be rotated and held at a certain degree and the entire module can be rotated and held, as the lighting systems are rotationally hinge-combined to each other by the connecting member 70 which connects the holding bracket 60a provided in the external side of the base 20 with the holding bracket 60b provided in the external side of the heat sink 30. Subsequently, the present invention has advantages in that the distribution of the light amount can be easily achieved and the lighting system can be mounted in various locations and used as various purposes.

According to lighting system of the present invention, the heat sink is connected through the heat pipe in lateral horizontal direction of the printed circuit board with the light emitting board to considerably improve the heat-radiation performance by natural convection, thereby to achieving a miniaturization of the enter lighting system along with a miniaturization of the heat sink and also achieving a lower production cost and a wide mounting area.

Further, it is possible easily to control the illuminating angle and the illuminating range of the lighting system as the lighting system can be rotated in the left and right direction about the axis.

Further, as the modularization of the lighting system is facilitated, the amount of light can be increased or reduced according to situations of the mounting locations, i.e., the distribution of the light energy can be easily achieved.

While the present invention has been described with respect to the specific embodiments, it will be apparent to those skilled in the art that various changes and modifications may be made without departing from the spirit and scope of the invention as defined in the following claims.

What is claimed is:

1. A lighting system, comprising:
a printed circuit board 10 on which a plurality of light emitting diodes 11 are arranged;
a base which holds the printed circuit board 10;
a heat sink 30 which is provided on a lateral side of the base 20 in a horizontal direction of the printed circuit board 10;
a heat pipe 40 which connects the base 20 with the heat sink 30; and
a rotating unit 50 which is provided in at least end portion of one end portions and the other end portions of the base 20 or the heat sink 30.

2. The lighting system of claim 1, wherein the rotating unit 51 is provided with an angle control unit 51.

3. The lighting system of claim 1, wherein the heat sink 30 is provided with a housing 35 having an air-passing portion 36 formed.

4. The lighting system of claim 1, wherein the base 20 is provided with a first setting unit 21 which surrounds one portion or all of an outer circumference of the heat pipe 40.

5. The lighting system of claim 1, wherein the heat sink 30 is provided with a second setting unit 31 which surrounds one portion or all of an outer circumference of the heat pipe 40.

6. The lighting system of claim 1, wherein the lighting system 100 is provided with a holding bracket 60 having a rotation guide unit 61 which is fitted into the rotating unit 51 to guide it to rotate in a left side and a right side about an axis direction.

7. The lighting system of claim 6, wherein at least one rotation guide unit 61 is provided.

8. The lighting system of claim 6, wherein the holding bracket 60 is made from a metal material and provided with a heat-radiation facilitating means 62 on a surface thereof.
